(19) United States
(12) Patent Application Publication
(10) Pub. No.: US 2007/0116395 A1
(43) Pub. Date: May 24, 2007

(54) Ball bearing

(76) Inventor: Tsukasa Toyoda, Iwata (JP)

Correspondence Address: WENDEROTH, LIND & PONACK, L.L.P., 2033 K STREET N. W., SUITE 800, WASHINGTON, DC, 20006-1021, US

(21) Appl. No.: 11/602,329

(22) Filed: Nov. 21, 2006

(30) Foreign Application Priority Data
Nov. 24, 2005 (JP) 2005-338893

(51) Int. Cl. F16C 33/38

(52) U.S. Cl. 384/533

(57) ABSTRACT

A retainer of a ball bearing is provided in which collisions between the retainer and the balls are reduced even though the balls rotate alternately faster and slower than the retainer at short intervals, without reducing the stiffness of bridges of the retainer or without reducing the connecting spaces for connecting portions of the retainer. The retainer has elliptical pockets to define spaces in the rotational direction of the bearing between the pockets and the balls. The spaces account for 4-10%, preferably 6-10%, of the diameter of the balls, thereby reducing collisions between the retainer and the balls even when the balls rotate alternately faster and slower than the retainer at short intervals, without reducing the stiffness of the bridges.

### BACKGROUND OF THE INVENTION

This invention relates to a ball bearing such as a deep groove ball bearing or an angular ball bearing.

A wide variety of retainers are used in ball bearings such as deep groove ball bearings and angular ball bearings. Such retainers include a crown-shaped one having a plurality of bridges extending from an annular portion in one axial direction of the bearing and defining pockets therebetween, one having a pair of annular portions on its both sides which are connected to each other by a plurality of bridges defining pockets therebetween, and one formed by a pair of annular members each comprising hemispherical pockets and connecting portions provided between the adjacent hemispherical pockets, and connected together at the connecting portions. Many of such retainers have circular pockets (with a discontinuous portion for crown-shaped retainers). Equal spaces are provided between such pockets and the balls in the rotational and axial directions of the bearing.

Some retainers include elliptical pockets, defining smaller and larger spaces in the axial and rotational directions of the bearing, respectively, between the pockets and the balls, so as to increase the contact area between the balls and the pockets, thereby reducing the contact pressure therebetween (for example, see Japanese patent publication 58-180839).

In a ball bearing which supports a rotary shaft which is frequently subjected to acceleration and deceleration, such as a speed change shaft mounted in an automotive transmission, the balls in the pockets rotate alternately faster and slower than the retainer at short intervals. Thus, if the retainer has circular pockets, the balls tend to repeatedly collide against the retainer. This may damage the retainer.

As a countermeasure against the above-mentioned problem, the retainer may have elliptical pockets to define larger spaces in the rotational direction as disclosed in Japanese patent publication 58-180839. However, in this case, if the spaces in the rotational direction are not large enough, the frequency of collisions might not decrease sufficiently.

If the spaces in the rotational direction are too large, the pockets account for a larger part of the retainer in the rotational direction. This reduces the sectional area of the bridges defined between the pockets (if such bridges are actually defined between the pockets) and thus the stiffness thereof. In the case of a retainer formed by two annular members including hemispherical pockets and connecting portions provided between the adjacent hemispherical pockets and connected together at the connecting portions, the connecting spaces at the connecting portions tend to be insufficient. The number of pockets may be decreased to prevent such a problem. However, in this case, the number of balls and thus the load capacity of the bearing also decrease.

An object of the present invention is to reduce collisions between the retainer and the balls even though the balls rotate alternately faster and slower than the retainer at short intervals, without decreasing the stiffness of the bridges of the retainer or the connecting spaces at the connecting portions.

### SUMMARY OF THE INVENTION

According to the present invention, there is provided a ball bearing comprising an inner ring having a raceway groove, an outer ring having a raceway groove, a plurality of balls disposed between the raceway grooves, and a retainer retaining the balls in pockets formed in the retainer, wherein the pockets of the retainer are elliptical pockets with or without a discontinuous portion, whereby spaces in the rotational direction of the ball bearing are defined between the pockets and the balls, the spaces being 4-10% of the diameter of the balls.

More specifically, the ball bearing according to the present invention comprises the retainer having the pockets which are elliptical or elliptical with a discontinuous portion to receive the balls, and the spaces are provided between the pockets and the balls in the rotational direction of the bearing, the spaces being designed to account for 4-10%, preferably 6-10%, of the diameter of the balls, so as to reduce collisions between the retainer and the balls even though the balls rotate alternately faster and slower than the retainer at short intervals, without reducing the stiffness of the bridges of the retainer or the connecting spaces at the connecting portions.

The pockets in the rotational direction account for not less than 4%, preferably not less than 6%, of the diameter of the balls, based on a calculation result which has shown that the maximum distance by which the balls rotate relative to the retainer was 4-6% of the diameter of the balls when a speed change shaft of an automotive transmission supported by the ball bearing was accelerated and decelerated. The spaces in the rotational direction defined between the pockets and the balls are determined not to exceed 10% of the diameter of the balls, because otherwise the sectional area of the bridges and thus their stiffness decrease if the retainer has such bridges between the pockets, and if the retainer comprises a pair of annular members having hemispherical pockets and connecting portions provided between the adjacent pockets, and connected together at the connecting portions, the connecting spaces at the connecting portions tend to be insufficient.

The retainer may be formed by pressing a metal sheet.

Alternatively, the retainer may be formed by injection molding of resin.

Further alternatively, the retainer may be formed by cutting a metal material or a resin material.

The ball bearing according to the present invention is preferably used to support a speed change shaft mounted in an automotive transmission.

The ball bearing according to the present invention comprises the retainer having the pockets which are elliptical or elliptical with a discontinuous portion to receive the balls, and the spaces are provided between the pockets and the balls in the rotational direction of the bearing, the spaces being 4-10%, preferably 6-10%, of the diameter of the balls. With this arrangement, it is possible to reduce collisions between the balls and the retainer, without reducing the stiffness of the bridges of the retainer or the connecting spaces at the connecting portions.

### BRIEF DESCRIPTION OF THE DRAWINGS

FIG. 1A is a vertical sectional view of a ball bearing according to a first embodiment of the present invention;

FIG. 1B is a partial developed plan view of a retainer of the ball bearing of FIG. 1A;

FIG. 2 is a vertical sectional schematic view of an automotive transmission in which the ball bearing shown in FIG. 1A is used;

FIG. 3A is a vertical sectional view of a ball bearing according to a second embodiment of the present invention;

FIG. 3B is a partial developed plan view of a retainer of the ball bearing of FIG. 3A;

FIG. 4A is a vertical sectional view of a ball bearing according to a third embodiment of the present invention;

FIG. 4B is a partial developed plan view of a retainer of the ball bearing of FIG. 4A;

FIG. 5A is a vertical sectional view of a ball bearing according to a fourth embodiment of the present invention; and

FIG. 5B is a partial developed plan view of a retainer shown in 5A.

### DETAILED DESCRIPTION OF THE PREFERRED EMBODIMENTS

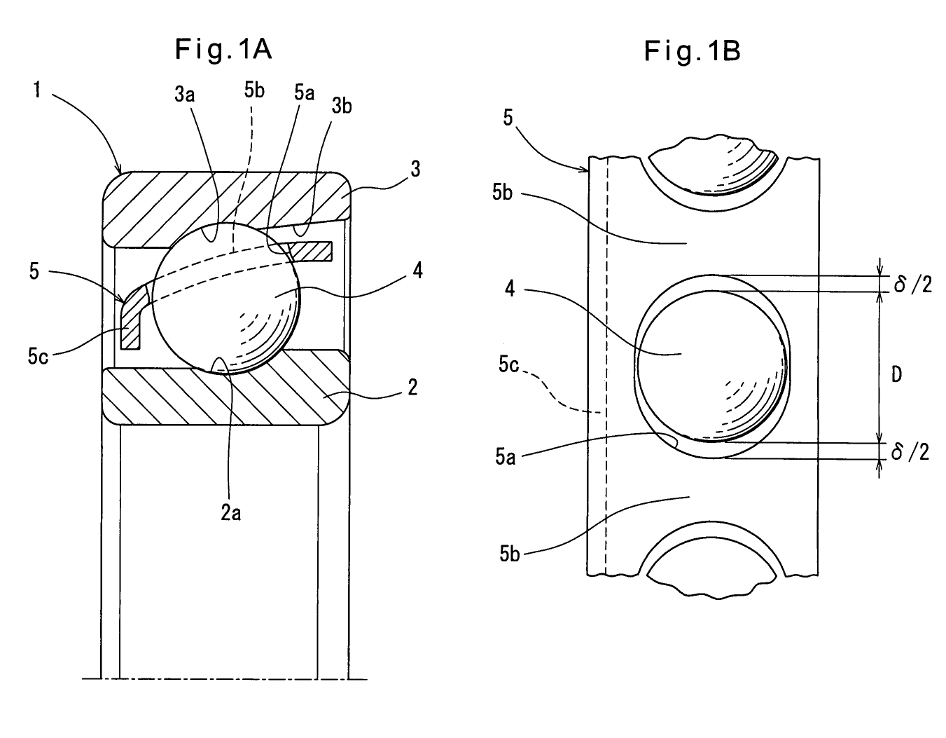

Now referring to the drawings, FIGS. 1A and 1B show a ball bearing according to the first embodiment of this invention. It is an angular ball bearing 1 comprising an inner ring 2 having a raceway groove 2a, an inner ring 3 having a raceway groove 3a, a plurality of balls 4 disposed between the raceway grooves 2a and 3a, and a retainer 5 retaining the balls 4. A countersink 3b is formed in the outer ring 3 on one side of the raceway groove 3a.

The retainer 5 is an annular member formed by pressing a metal sheet and has pockets 5a formed by punching. The balls 4 are each received in one of the pockets 5a. The retainer 5 includes annular portions formed on both sides of the pockets 5a and connected to each other by bridges 5b defined between the adjacent pockets. A flange 5c is provided on one of the annular portions for reinforcement. The pockets 5a of the retainer 5 are elliptical ones with their major axis extending in the rotational direction of the bearing. Spaces δ are defined in the rotational direction between the pockets 5 and the balls 4. The spaces δ are 6-10% of the diameter D of the balls 4.

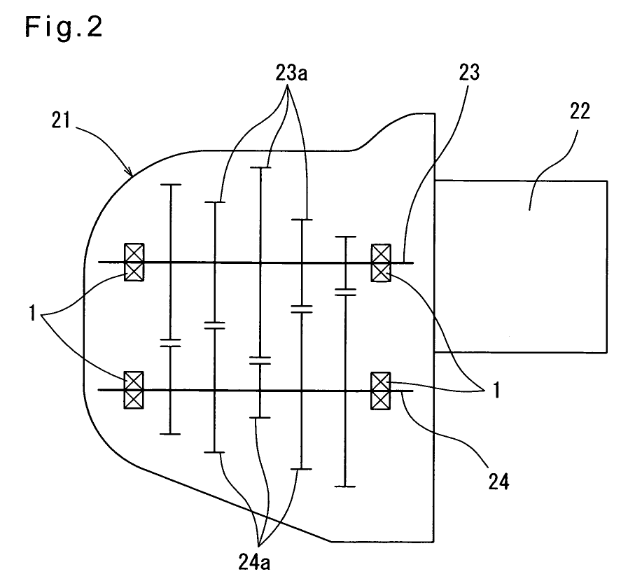

FIG. 2 shows a transmission 21 for an automobile in which angular ball bearings 1 of the first embodiment are used. The transmission 21 comprises a first speed change shaft 23 to which the power of an engine 22 is transmitted through a clutch, and a second speed change shaft 24 which transmits the engine power to the wheels. The speed change shafts 23 and 24, to which a plurality of transmission gears 23a and 24a are respectively mounted, have both ends thereof supported by the angular ball bearings 1.

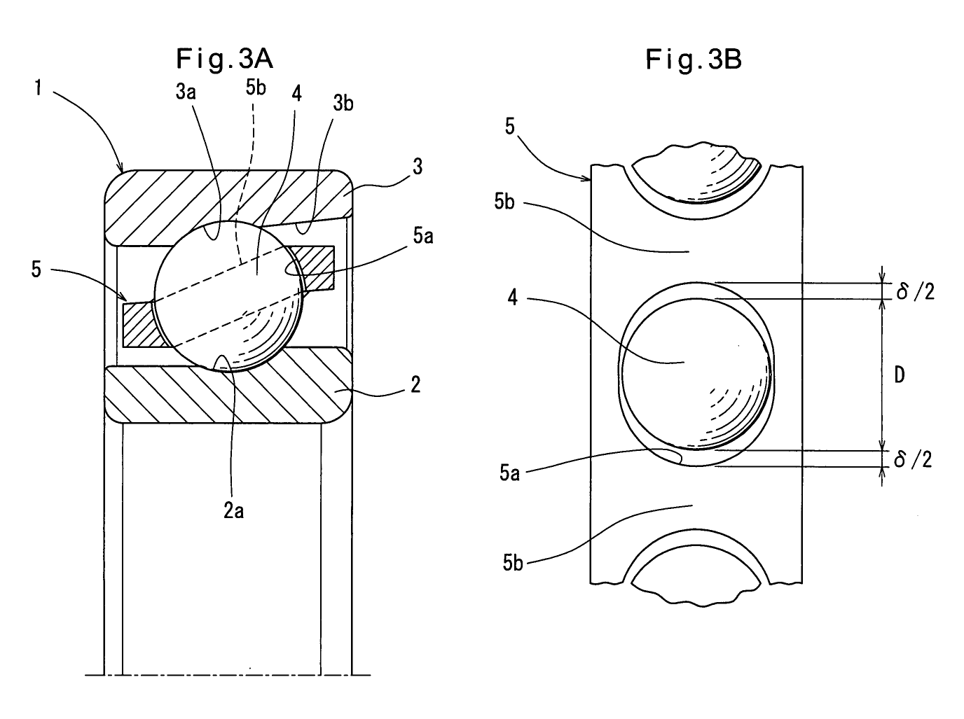

FIGS. 3A and 3B show the second embodiment of this invention. The ball bearing 1 of this embodiment is an angular ball bearing as with the first embodiment, and includes a retainer 5. The retainer 5 is formed by injection molding of resin, and includes annular portions on both sides of elliptical pockets 5a and connected to each other by bridges 5b defined between the adjacent pockets. As with the first embodiment, spaces δ in the rotational direction defined between the elliptical pockets 5a and balls 4 are 6-10% of the diameter of the balls 4.

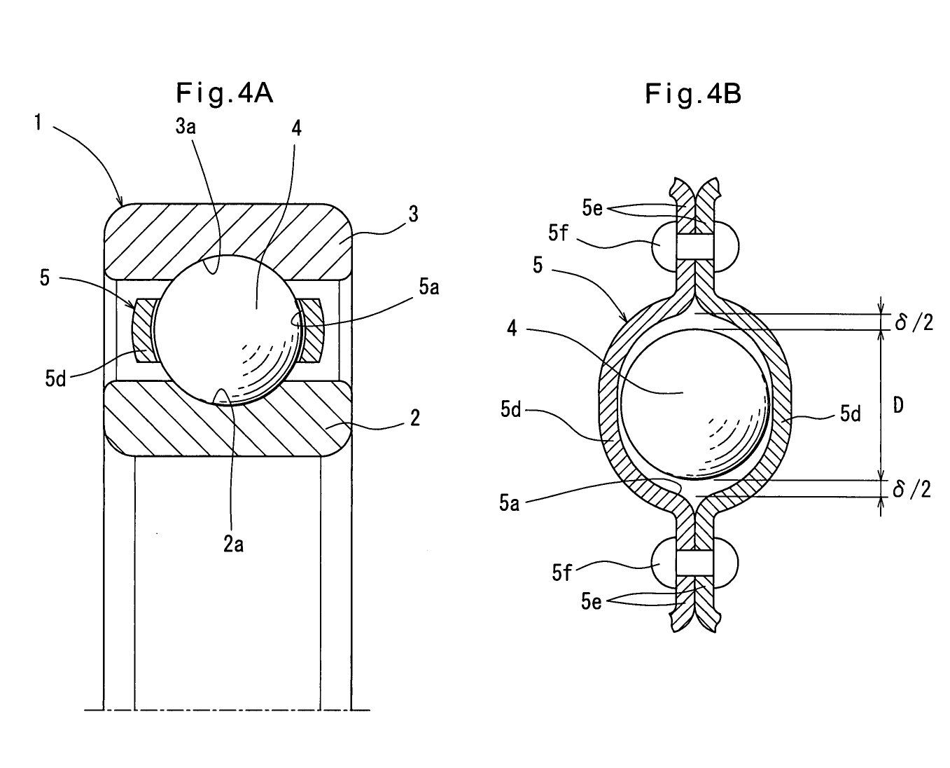

FIGS. 4A and 4B show the third embodiment of this invention. The ball bearing 1 of this embodiment is a deep groove ball bearing and includes a retainer 5. The retainer 5 retains a plurality of balls 4 disposed between a raceway groove 2a of an inner ring 2 and a raceway groove 3a of an outer ring 3. The retainer 5 comprises a pair of annular members. Each annular member is formed by pressing a metal sheet, and includes hemispherical recesses 5d and connecting portions 5e provided between the adjacent recesses 5d. The respective hemispherical recesses 5d of one annular member face their counterparts of the other annular member so as to define pockets 5a. The two annular members are connected to each other by studs 5f at the connecting portions 5e. The pockets 5a defined by the recesses 5d are elliptical, and spaces δ in the rotational direction of the bearing are provided between the pockets 5a and the balls 4. The spaces δ are 6-10% of the diameter of the balls 4 as with the first embodiment.

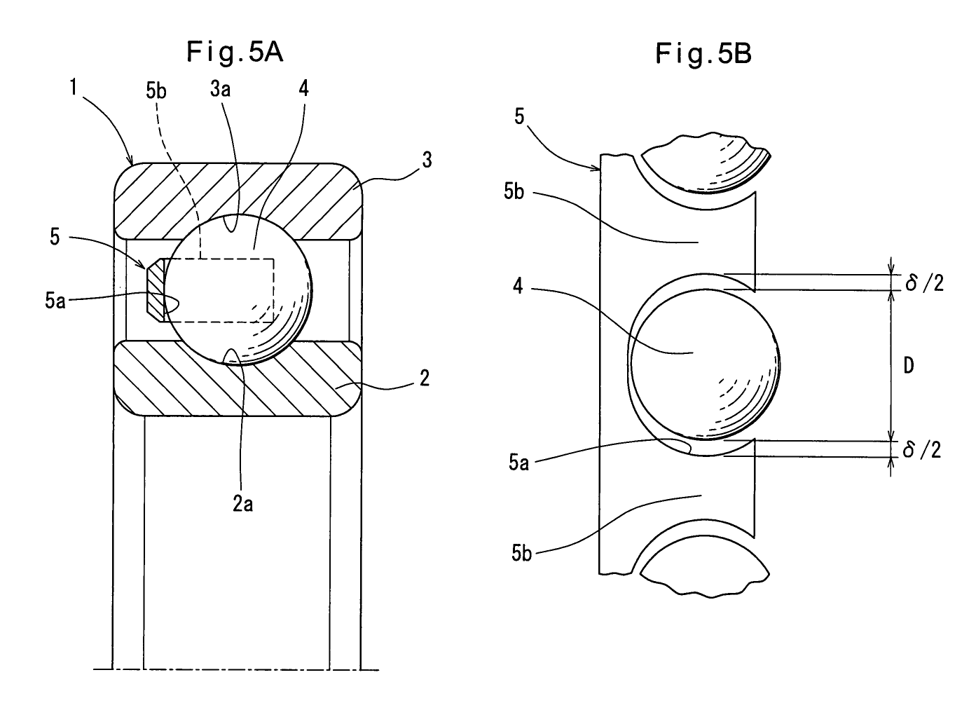

FIGS. 5A and 5B show the fourth embodiment of this invention. The ball bearing of this embodiment is a deep groove ball bearing as with the third embodiment, and includes a retainer 5 formed by cutting a metal material. The retainer 5 comprises an annular portion and a plurality of bridges 5b extending from the annular portion in one axial direction of the bearing. Pockets 5a are defined between the adjacent bridges 5b. Thus, the retainer 5 is crown-shaped as a whole. The pockets 5a are elliptical with a discontinuous portion. Spaces δ in the rotational direction of the bearing are defined between the pockets 5 and the balls 4. The spaces δ are 6-10% of the diameter of the balls 4 as with the first embodiment.

In each of the above-mentioned embodiments, the spaces δ in the rotational direction of the bearing disposed between the pockets and the balls are 6-10% of the diameter D of the balls 4. Alternatively, the spaces δ may account for 4-6% of the diameter D of the balls 4.

What is claimed is:

1. A ball bearing comprising an inner ring having a raceway groove, an outer ring having a raceway groove, a plurality of balls disposed between said raceway grooves, and a retainer retaining said balls in pockets formed in said retainer, wherein said pockets of said retainer are elliptical pockets with or without a discontinuous portion, whereby spaces in the rotational direction of said ball bearing are defined between said pockets and said balls, said spaces being 4-10% of the diameter of said balls.

2. The ball bearing of claim 1 wherein said retainer is formed by pressing a metal sheet.

3. The ball bearing of claim 1 wherein said retainer is formed by injection molding of resin.

4. The ball bearing of claim 1 wherein said retainer is formed by cutting a metal material or a resin material.

5. The ball bearing of claim 1, wherein said ball bearing supports a speed change shaft of a transmission of a vehicle.

6. The ball bearing of claim 2, wherein said ball bearing supports a speed change shaft of a transmission of a vehicle.

7. The ball bearing of claim 3, wherein said ball bearing supports a speed change shaft of a transmission of a vehicle.

8. The ball bearing of claim 4, wherein said ball bearing supports a speed change shaft of a transmission of a vehicle.
